(19) United States
(12) Patent Application Publication
(10) Pub. No.: US 2025/0049125 A1
(43) Pub. Date: Feb. 13, 2025

(54) ELECTRONIC VAPOUR PROVISION DEVICE

(71) Applicant: Nicoventures Trading Limited, London (GB)

(72) Inventors: Damyn MUSGRAVE, London (GB); Jason WOOD, Winston Salem, NC (US); Jason SHORT, Winston Salem, NC (US); Stephen SEARS, Winston Salem, NC (US)

(21) Appl. No.: 18/720,078

(22) PCT Filed: Dec. 19, 2022
(86) PCT No.: PCT/EP2022/086801

§ 371 Date: Jun. 14, 2024

Related U.S. Application Data
(60) Provisional application No. 63/265,651, filed on Dec. 17, 2021.
(60) Provisional application No. 63/265,654, filed on Dec. 17, 2021.
(60) Provisional application No. 63/265,655, filed on Dec. 17, 2021.
(60) Provisional application No. 63/265,656, filed on Dec. 17, 2021.
(60) Provisional application No. 63/383,895, filed on Nov. 15, 2022.

(30) Foreign Application Priority Data
Jun. 20, 2022 (GB) 2209031.0
Jun. 20, 2022 (GB) 2209040.1
Jun. 20, 2022 (GB) 2209044.3
Jun. 20, 2022 (GB) 2209050.0

(51) Int. Cl. A24F 40/46; A24F 40/10; A24F 40/51; A24F 40/57; H04B 5/43; H05B 6/64

(52) U.S. Cl. CPC A24F 40/46; A24F 40/10; A24F 40/51; A24F 40/57; H04B 5/43; H05B 6/6408

(57) ABSTRACT

An electronic vapor provision device is disclosed including at least one antenna for generating radio frequency (RF) electromagnetic radiation for heating an aerosol generating material to generate vapor, and a controller for controlling one or more properties of the RF electromagnetic radiation generated by the at least one antenna. The controller is configured to cause the at least one antenna to generate the microwave radiation in accordance with a predetermined schema which defines one or more properties of the RF electromagnetic radiation.

### RELATED APPLICATIONS

The present application is a National Phase entry of PCT Application No. PCT/EP2022/086801 filed Dec. 19, 2022, which claims priority to U.S. Provisional Application No. 63/265,651 filed Dec. 17, 2021, U.S. Provisional Application No. 63/265,654 filed Dec. 17, 2021, U.S. Provisional Application No. 63/265,655 filed Dec. 17, 2021, U.S. Provisional Application No. 63/265,656 filed Dec. 17, 2021, GB Application No. 2209044.3 filed Jun. 20, 2022, GB Application No. 2209040.1 filed Jun. 20, 2022, GB Application No. 2209050.0 filed Jun. 20, 2022, GB Application No. 2209031.0 filed Jun. 20, 2022, and U.S. Provisional Application No. 63/383,895 filed Nov. 15, 2022, each of which is hereby incorporated by reference in their entirety.

### TECHNICAL FIELD

The present invention relates to an electronic vapor provision device, an electronic vapor provision system and a method of generating vapor.

### BACKGROUND

Known aerosol provision systems operate by applying heat to an aerosol generating material, in order to cause a release of aerosol. This heat may be applied in some systems by resistive heating of a heating element which is exposed to the aerosol generating material, or alternatively by inductive heating in which a varying magnetic field is applied to a susceptor element which becomes heated as a result. However, further approaches to heating aerosol generating material are sought.

### SUMMARY

According to an aspect there is provided an electronic vapor provision device comprising: at least one antenna for generating radio frequency (RF) electromagnetic radiation for heating an aerosol generating material to generate vapor; and a controller for controlling one or more properties of the RF electromagnetic radiation generated by the at least one antenna, wherein the controller is configured to cause the at least one antenna to generate the microwave radiation in accordance with a predetermined schema which defines one or more properties of the RF electromagnetic radiation.

Optionally, the controller is configured to cause the at least one antenna to generate RF electromagnetic radiation for generating the vapor from the aerosol generating material in a heating cycle, and wherein the predetermined schema defines one or more properties of the RF electromagnetic radiation generated in the heating cycle.

Optionally, the controller is configured to prepare the predetermined schema in advance of the heating cycle.

Optionally, the controller is configured to prepare the predetermined schema by defining, selecting, or receiving the predetermined schema in advance of the heating cycle.

Optionally, the one or more properties of the RF electromagnetic radiation comprises the frequency of the RF electromagnetic radiation.

Optionally, the one or more properties of the RF electromagnetic radiation comprises the power of the RF electromagnetic radiation.

Optionally, the one or more properties of the RF electromagnetic radiation comprises the spatial distribution of the RF electromagnetic radiation.

Optionally, the electronic vapor provision device comprises: a user interface for receiving inputs from a user and configured to send instruction signals relating to the received inputs to the controller; and/or a signal receiver configured to connect to a secondary device, receive signals relating to user inputs on the secondary device, and send instruction signals relating to the received signals to the controller.

Optionally, the controller is configured to define or select the predetermined schema in dependence of the instruction signals received by the controller.

Optionally, the controller is configured to define or select the predetermined schema in response to receiving the instruction signals.

Optionally, the controller is configured to define or select the predetermined schema in dependence of properties of the aerosol generating material received by the electronic vapor provision device.

Optionally, the electronic vapor provision device comprises a heating cavity configured to receive the aerosol generating material, and one or more sensors for determining one or more respective measured properties relating to the aerosol generating material.

Optionally, the electric vapor provision device is configured to receive a consumable comprising aerosol generating material, and wherein the one or more sensors comprises a consumable identification sensor, wherein the measured property determined by the consumable identification sensor is an identity of a consumable received by the electronic vapor provision device.

Optionally, the controller comprises memory, and the controller is configured to select the predetermined schema from a plurality of stored predetermined schema which are stored in the memory.

Optionally, the controller is configured to vary the one or more properties of the RF electromagnetic radiation in accordance with the predetermined schema.

According to another aspect there is provided an electronic vapor provision device comprising:
at least one antenna for generating radio frequency (RF) electromagnetic radiation for heating an aerosol generating material to generate vapor; and
a controller for controlling one or more properties of the RF electromagnetic radiation generated by the at least one antenna.

Any of the features described above may be applied to the electronic vapor provision device of this aspect.

According to another aspect there is provided an electronic vapor provision system comprising:
an electronic vapor provision device as described above; and
a supply of liquid which in use is vaporized to form a vapor for inhalation by a user.

According to another aspect there is provided a method of generating vapor comprising:
generating radio frequency (RF) electromagnetic radiation for heating an aerosol generating material to generate vapor; and
controlling one or more properties of the RF electromagnetic radiation generated by the at least one antenna by causing the at least one antenna to generate the microwave radiation in accordance with a predetermined schema which defines one or more properties of the RF electromagnetic radiation.

### BRIEF DESCRIPTION OF DRAWINGS

Various embodiments will now be described, by way of example only, and with reference to the accompanying drawings in which:

FIG. 1 shows a cross-sectional view through a schematic representation of an electronic vapor provision device in accordance with certain embodiments;

FIG. 2 shows a cross-sectional view through a schematic representation of a heating assembly of an electronic vapor provision device in accordance with certain embodiments; and

FIG. 3 shows a cross-sectional view through a schematic representation of an electronic vapor provision device in accordance with certain embodiments.

### DETAILED DESCRIPTION

Aspects and features of certain examples and embodiments are discussed or described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to vapor provision devices, such as e-cigarettes, including hybrid devices. Throughout the following description the term “e-cigarette” or “electronic cigarette” may sometimes be used, but it will be appreciated this term may be used interchangeably with vapor provision system/device and electronic vapor provision system/device. Furthermore, and as is common in the technical field, the terms “vapor” and “aerosol”, and related terms such as “vaporize”, “volatilise” and “aerosolize”, may generally be used interchangeably.

An aerosol provision device is used to generate aerosol from an aerosol-generating material. Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid. The aerosol-generating material may comprise one or more active substances and/or flavors, one or more aerosol-former materials, and optionally one or more other functional material. In some embodiments, the aerosol-generating material comprises a crystalline structure.

The construction of the aerosol provision device may change depending upon the form of the aerosol-generating material which it is configured to generate aerosol from. However, while examples will be discussed below with regard to various different forms of aerosol-generating material, and correspondingly different aerosol provision device constructions, the heating techniques discussed herein may be applied in all forms of the aerosol-generating material.

Systems for generating aerosol often, though not always, comprise a modular assembly including both a reusable part (e.g. the aerosol provision device) and a replaceable (disposable) cartridge part, also referred to as a consumable. Often the replaceable cartridge part will comprise the vapor precursor material and the vaporizer and the reusable part will comprise the power supply (e.g. rechargeable battery), activation mechanism (e.g. button or puff sensor), and control circuitry. However, it will be appreciated these different parts may also comprise further elements depending on functionality. For example, for a hybrid device the cartridge part may also comprise the additional flavor element, e.g. a portion of tobacco, provided as an insert (“pod”). In such cases the flavor element insert may itself be removable from the disposable cartridge part so it can be replaced separately from the cartridge, for example to change flavor or because the usable lifetime of the flavor element insert is less than the usable lifetime of the vapor generating components of the cartridge. The reusable device part will often also comprise additional components, such as a user interface for receiving user input and displaying operating status characteristics.

For modular systems a cartridge and reusable device part are electrically and mechanically coupled together for use, for example using a screw thread, latching, friction-fit, or bayonet fixing with appropriately engaging electrical contacts. When the vapor precursor material in a cartridge is exhausted, or the user wishes to switch to a different cartridge having a different vapor precursor material, a cartridge may be removed from the device part and a replacement cartridge attached in its place. Devices conforming to this type of two-part modular configuration may generally be referred to as two-part devices or multi-part devices.

It is relatively common for electronic cigarettes to have a generally elongate shape and, for the sake of providing a concrete example, certain embodiments of the disclosure described herein will be taken to comprise a generally elongate single-part device employing a liquid reservoir containing liquid vapor precursor material. However, it will be appreciated the underlying principles described herein may equally be adopted for different electronic cigarette configurations, for example multi-part devices employing disposable cartridges containing vapor precursor material, or modular devices comprising more than two parts, refillable devices and single-use disposable devices, and hybrid devices which have an additional flavor element, such as a tobacco pod insert, situated along the air flow path and upstream of the vaporizer, as well as devices conforming to other overall shapes, for example based on so-called box-mod high performance devices that typically have a more box-like shape.

Various embodiments will now be described in more detail.

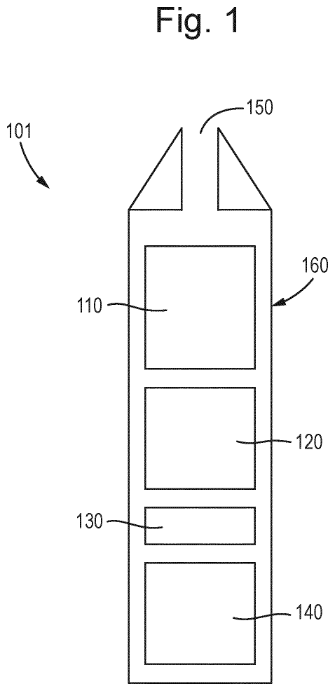

FIG. 1 is a cross-sectional view through a schematic representation of an electronic vapor provision device 101 in accordance with certain embodiments.

The electronic vapor provision device 101 comprises an outer housing 160, a power source 140, control circuitry 130, a one or more liquid sources 120, and a heating apparatus 110. The outer housing 160 may be formed from any suitable material, for example a plastics material. The outer housing 160 may also enclose the other components, namely the power source 140, the control circuitry 130, the one or more liquid sources 120, and the heating apparatus 110. The electronic vapor provision device 101 is a handheld electronic vapor device, meaning that the outer housing 160 enclosing the other components is dimensioned and configured to be held in the hand of a user. In other words, the device is portable.

The electronic vapor provision device 101 may further include a mouthpiece 150. The outer housing 160 and mouthpiece 150 may be formed as a single component (that is, the mouthpiece 160 forms a part of the outer housing 160). The mouthpiece 150 may be defined as a region of the outer housing 160 which includes an air outlet and is shaped in such a way that a user may comfortably place their lips around the mouthpiece 150 to engage with air outlet. In FIG. 1, the thickness of the outer housing 160 decreases towards the air outlet to provide a relatively thinner portion of the device 101 which may be more easily accommodated by the lips of a user. In other implementations, however, the mouthpiece 150 may be a removable component that is separate from but able to be coupled to the outer housing 160, and may be removed for cleaning and/or replacement with another mouthpiece 150.

The power source 140 is configured to provide operating power to the electronic vapor provision device 101. The power source 140 may be any suitable power source, such as a battery. For example, the power source 140 may comprise a rechargeable battery, such as a Lithium Ion battery. The power source 140 may be removable or form an integrated part of the electronic vapor provision device 101. In some implementations, the power source 140 may be recharged through connection of the device 101 to an external power supply (such as mains power) through an associated connection port, such as a USB port (not shown) or via a suitable wireless receiver (not shown).

The control circuitry 130 is suitably configured or programmed to control the operation of the aerosol provision device to provide certain operating functions of electronic vapor provision device 101. The control circuitry may also interchangeably be referred to as a “controller”. The control circuitry 130 may be considered to logically comprise various sub-units/circuitry elements associated with different aspects of the aerosol provision devices' operation. For example, the control circuitry 130 may comprise a logical sub-unit for controlling the recharging of the power source 140. Additionally, the control circuitry 130 may comprise a logical sub-unit for communication, e.g. to facilitate data transfer from or to the device 101. However, a primary function of the control circuitry 130 is to control the heating of aerosol generating material, as described in more detail below. It will be appreciated the functionality of the control circuitry 130 can be provided in various different ways, for example using one or more suitably programmed programmable computer(s) and/or one or more suitably configured application-specific integrated circuit(s)/circuitry/chip(s)/chipset(s) configured to provide the desired functionality. The control circuitry 130 is connected to the power supply 140 and may receive power from the power source 140 and may be configured to distribute or control the power supply to other components of the electronic vapor provision device 101. The control circuitry 130 is discussed as being connected to various components of the electronic vapor provision device 101, and it should be understood in each instance that this may be a direct or indirect connection.

The electronic vapor provision device 101 also comprises one or more liquid sources 120, each comprising a liquid reservoir containing liquid vapor precursor material. The liquid vapor precursor material may be referred to as an e-liquid. In embodiments, the one or more liquid sources 120 is arranged within the outer housing 160, but, as discussed above, in embodiments in which the electronic vapor provision device 101 is a multi-part or modular system, the one or more liquid sources 120 may be arranged within a disposable cartridge which is configured to be releasably coupled to the remainder of the electronic vapor provision device 101. That is to say, the cartridges are capable of being received by or in the vapor provision device 101.

Although specific embodiments are discussed in more detail below, each liquid reservoir may be formed in any shape compatible with the heating techniques discussed herein. The one or more liquid reservoirs may also be formed in accordance with conventional techniques, and for example it may comprise a plastics material, and may be integrally molded with the outer housing 160.

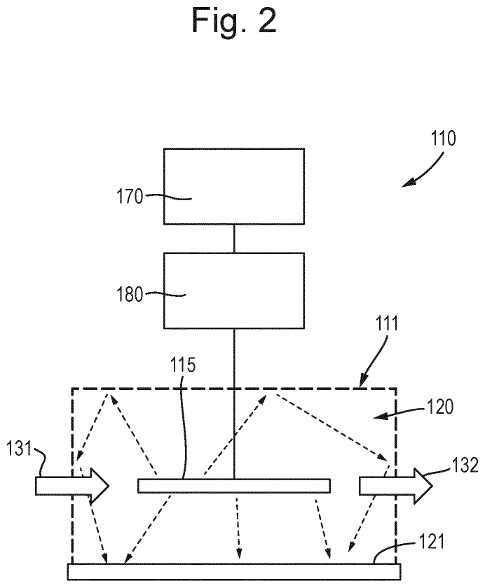

The electronic vapor provision device according to various embodiments may include a heating assembly 10 as shown schematically in FIG. 2. The heating assembly 10 may be connected to the control circuitry 30. According to various embodiments the heating assembly 10 uses radiofrequency (RF) electromagnetic radiation, such as microwave radiation, although other wavelengths may be used, to heat liquid vapor precursor material. RF electromagnetic radiation refers to electromagnetic radiation having a frequency within the range 30 Hz to 300 GHz. The RF electromagnetic radiation may have a frequency of 3 kHz to 300 GHz, optionally 3 MHz to 100 GHz, optionally 30 MHz to 30 GHz. The heating assembly 10 may comprise a signal generator 170, such as a voltage controlled oscillator (“VCO”), to generate a signal which is provided to a connected amplifier 180. The amplifier 180 may be connected to one or more antennas 115, which are arranged within a heating cavity 120. In some embodiments, the one or more antennas 115 comprises one or more patch antenna. In another embodiment, the one or more antenna 115 comprises one or more directional antenna. The control circuitry 30 can control the RF electromagnetic radiation which is generated by the one or more antennas 115, and in embodiments the frequency spectra which is generated by the one or more antennas 115. The one or more antennas 115 may also be referred to as an antenna arrangement 115.

The heating cavity 120 is defined by RF shield 111 which substantially prevents the RF electromagnetic radiation generated by the one or more antennas 115 from escaping from the heating cavity 120. The RF shield 311 defines the heating cavity 320, by delimiting the volume within which RF electromagnetic radiation is substantially prevented from escaping, as will be discussed below. The one or more antennas 115 are arranged within the heating cavity 120. RF electromagnetic radiation may be prevented from escaping the heating cavity 120 by a combination of reflection and absorption of the RF electromagnetic radiation and optionally the RF shield 111 may be configured to reflect more of the RF electromagnetic radiation back into the heating cavity 120 than is absorbed by the RF shield 111.

For instance, the RF shield 111 may be configured to have a directional reflectance of 0.5 to 1.0, optionally 0.7 to 1.0, for the RF electromagnetic radiation generated by the antennas 115, the directional reflectance being the radiant flux reflected by a surface, divided by that received by that surface. The RF shield 111 may be configured to have a directional absorptance of 0.0 to 0.7, optionally 0.1 to 0.5, for the RF electromagnetic radiation generated by the antennas, the directional absorptance being the radiant flux absorbed by a surface, divided by that received by that surface. Further, the RF shield 111 may be configured to have a directional transmittance 0.0 to 0.3, optionally 0.1 to 0.2, for the RF electromagnetic radiation generated by the antennas 115, the directional transmittance being the radiant flux transmitted by a surface, divided by that received by that surface. Additionally, the RF shield may be configured to have an effective attenuation coefficient of at least 0.05 mm⁻¹ optionally at least 0.1 mm⁻¹, optionally at least 0.2 mm⁻¹, optionally at least 0.5 mm⁻¹, for the RF electromagnetic radiation generated by the antennas, where the effective attenuation coefficient is the radiant flux absorbed and scattered by a volume per unit length, divided by that received by that volume.

In some embodiments the RF shield 111 comprises a conductive material, a magnetic material, advantageously a conductive and magnetic material, and may comprise metal, for example aluminum, copper, brass, nickel, or other metals. Aluminum, copper, brass, and nickel are particularly useful as they have a desirably high degree of reflectance and shininess, in addition to conductivity. The RF shield 111 may comprise a substrate (e.g. an electrically insulating substrate) with a metallic coating, such as metallic ink. In embodiments the RF shield 111 may comprise an alloy comprising aluminum or copper. In some embodiments the RF shield 111 comprises a reflective foil. The RF shield 111 may comprise a sheet metallic material. In other embodiments, the RF shield 111 may comprise a metallic gauze or mesh. For instance, the RF shield 111 may comprise openings having a width of 5 mm or less, optionally 2.5 mm or less, optionally 1.5 mm or less, optionally 1.0 mm or less, optionally 0.5 mm or less, optionally 0.2 mm or less, optionally 0.1 mm or less. While any of these dimensions of openings may be applied to the liquid transport region or air permeable regions, as discussed below, openings having a width of 2.5 mm or less may be well suited to allowing both air and liquid, and a mixture of air, liquid, and/or vapor, to pass through, while openings having a width of 0.5 mm or less may be suitable for allowing liquid to pass through. These narrow openings are sufficient to substantially prevent the escape of the RF electromagnetic radiation from the heating cavity 120, while still permitting fluid to pass there through. In embodiments, the openings may have a width which is smaller than the smallest wavelength of the RF electromagnetic radiation generated by the antennas 115. Further, in regions of the RF shield 111 which comprise openings, (e.g. the liquid transport region or air permeable regions, as discussed below) the openings may cover 20% to 80%, optionally 40% to 60%, of the surface area in these regions. This proportion of openings may enable desirable volumes of fluid to pass through the RF shield 111, while remaining structurally stable.

As such, when the one or more antennas 115 are used to generate RF electromagnetic radiation, material within the cavity may become heated by exposure to this radiation, through the mechanism of dielectric heating in which polar molecules of the material within the cavity are driven to rotate by the RF electromagnetic radiation, thereby causing the material within the cavity to be vaporized. However, the RF shield 111 may be arranged to substantially prevent the RF electromagnetic radiation from escaping the cavity 120. This is important, particularly for an electronic vapor provision device which is handheld, as any RF electromagnetic radiation which did escape from the heating cavity 120 would escape in close proximity to the user. In one regard, providing the RF shield can help prevent the escape of RF radiation outside of the RF shield and thus provide a relatively safe heating mechanism (in respect of preventing the user from being exposed to RF radiation). Additionally, in instances where the RF shield is at least partially reflective to the RF radiation, the intensity of RF electromagnetic radiation generated may be increased within the bounds of the RF shield.

As will be discussed in more detail below with regard to exemplary embodiments, liquid vapor precursor material may be provided to the heating cavity 120 by liquid transport region 121 of the RF shield 111. In order to enable liquid vapor precursor material to enter the heating cavity 120, while still containing the RF electromagnetic radiation, the liquid transport region 121 corresponds to a portion of the RF shield 111 which is configured to permit the passage of fluid thereacross, but which is still configured such that RF electromagnetic radiation is substantially prevented from traversing, i.e. escaping the heating cavity 120. Accordingly, the liquid transport region 121 allows liquid to enter the heating assembly without requiring a gap in the RF shield which would substantially permit RF electromagnetic radiation to escape.

To achieve this, the liquid transport region 121 of the RF shield 111 comprises openings which are dimensioned to permit the flow of liquid there through, but which are of a dimension which substantially prevents RF electromagnetic radiation from passing there through, which may have the dimensions discussed above. As will be discussed in more detail below, the liquid transport region 121 may be defined by one or more wicking members, which are configured to transfer liquid from a liquid source across the RF shield 111 by capillary action. It should be understood that the extent or magnitude of the capillary action may be affected both by the properties of the liquid that is being wicked (e.g., the viscosity) as well as the size of the openings (or more generally capillary channels) of the liquid transport region 121. However, although many of the following examples will be discussed in the context of liquid transport regions being provided by one or more wicking members, these may each be applied more generally to arrangements in which the one or more liquid transport regions are provided that may or may not have wicking properties. In other words, the one or more wicking members may be generalised to one or more liquid transport regions which permit the transmission of fluid there across, but prevent the transmission of RF electromagnetic radiation thereacross.

As shown in detail in the various embodiments discussed below, the liquid transport region 121 of the RF shield 111 is in fluid communication with the one or more liquid sources 20. Liquid vapor precursor material is able to flow from the one or more liquid reservoirs, and through the liquid transport region 121 into the heating cavity 120. The liquid transport region 121 may comprise one or more liquid transport regions 121 arranged in distinct regions with respect to the heating cavity 120, each in fluid communication with a corresponding liquid source of the one or more liquid source. In embodiments, the liquid vapor precursor material may be drawn by capillary action through the liquid transport region 121. Each liquid source 20 may comprise a flow control element which is configured to control the flow of liquid from the liquid reservoir of liquid source, and the one or more liquid sources 20 may be connected to the control circuitry 30, such that flow from each liquid reservoir into the heating cavity 120 may be controlled by the control circuitry 30. Alternatively, the liquid transport region 121 may be arranged to provide certain liquid feed rates (e.g., by suitable number of openings/size of openings relative to the properties of the respective liquid source) to control the relative amounts of the liquids within the RF shield 111.

Once inside the cavity, the liquid vapor precursor material may be retained by a support structure (not shown) which is configured to retain liquid vapor precursor material within the cavity. In the case that multiple liquid transport regions are present, each may be configured to deliver liquid vapor precursor material to a respective support structure. This support structure may be (a region of) the inner wall of the RF shield 111 (e.g. at the liquid transport region), and/or may be a separate support structure arranged within the heating cavity 120, i.e. an internal support structure. As well as substantially preventing the RF electromagnetic radiation from escaping the heating cavity 120, the RF shield 111 may also be configured so as to best direct the radiation towards the support structure, and the liquid vapor precursor material retained thereby. When the one or more antennas 115 are used to generate RF electromagnetic radiation within the heating cavity 120, it is this liquid vapor precursor material which is within the cavity and retained by the support structure which is heated, and at least partially vaporized to generate vapor in the heating cavity 120. This may be a relatively small amount of liquid vapor precursor material, so advantageously it may be heated and vaporized quite quickly. As such it is also important to ensure that the control circuitry 30 is configured to control the heating assembly 10 in a manner which ensures that this vaporization occurs under optimal conditions, as will be discussed in more detail. To this end, the heating assembly 10 may comprise one or more sensors, including a temperature sensor, a chemical sensor, and/or a moisture sensor, for detecting the conditions in the cavity, the one or more sensors being connected to the control circuitry 30. Alternatively, the temperature could be estimated using an algorithm, such as an algorithm applying observer control theory, or artificial intelligence and/or machine learning.

The electronic vapor provision device 101 may comprise an air flow path extending between the heating cavity 120, which acts as a vapor generation chamber, and an air outlet such as an opening in the mouthpiece, so that a user inhaling on the outlet via the mouthpiece may draw air from the heating cavity 120, including any vapor in the heating cavity 120 which has been generated from the liquid vapor precursor material, for inhalation by the user. The flow path may begin at an air inlet, such as an inlet in the outer housing (not shown), for directing air towards the heating cavity 120, and is defined by one or more air channels (not shown). In order to facilitate this airflow through the heating cavity 120, the RF shield 111 can also comprise air permeable regions, which may comprise openings in the RF shield 111, which nonetheless still substantially prevent the escape of RF electromagnetic radiation from the cavity. These air permeable regions of the RF shield 111 may comprise openings of width 2.5 mm or less, and may be metallic as discussed above. This allows airflow 131 into the heating cavity 120, which can collect vapor which has been generated by the dielectric heating within the cavity, and leave the heating cavity as airflow 132 to be inhaled by a user. As shown in FIG. 2, and the subsequent Figs., the airflow entering and/or leaving the heating cavity is indicated by one or more arrows which pass through the RF shield, which indicate an exemplary passage of airflow (optionally including vapor generated in the cavity during use) through the RF shield. In order to facilitate this, a first air permeable region may be arranged at one side of the heating cavity 120, and a second air permeable region is arranged at the other, opposing, side of the heating cavity 120, such that air is drawn into the heating cavity (e.g. from the air inlet), through the first air permeable region, through the heating cavity, and out of the second air permeable region.

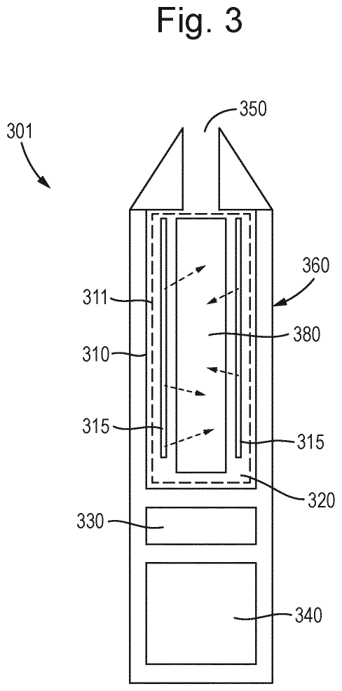

In other embodiments, as shown schematically in FIG. 3, the vapor provision device 301 may be for generating aerosol from a solid or gel aerosol generating material. Similarly to the liquid aerosol generating material system shown in FIG. 1, the electronic vapor provision device 301 comprises an outer housing 360, a power source 340, control circuitry 330, and a heating apparatus 310. However, the electronic vapor provision device 301 does not comprise a liquid source. Where practical, the vapor provision device 301 may have any of the features discussed above with regard to the aerosol provision device 101.

As with the arrangement shown in FIG. 1, the outer housing 360 may be formed from any suitable material, for example a plastics material. The outer housing 360 may also enclose the other components, namely the power source 340, the control circuitry 330, and the heating apparatus 310. The electronic vapor provision device 301 is a handheld electronic vapor device, meaning that the outer housing 360 enclosing the other components is dimensioned and configured to be held in the hand of a user. In other words, the device is portable. Similarly to the arrangement shown in FIG. 1, the electronic vapor provision device 301 may further include a mouthpiece 350, having analogous features to the arrangement of FIG. 1.

The power source 340 may also be configured in the same manner as that of FIG. 1, to provide operating power to the electronic vapor provision device 301, and may have the same features. Likewise, the control circuitry 330 is suitably configured or programmed to control the operation of the aerosol provision device to provide certain operating functions of electronic vapor provision device 301. The control circuitry may also interchangeably be referred to as a “controller”. The control circuitry 330 may be considered to logically comprise various sub-units/circuitry elements associated with different aspects of the aerosol provision devices' operation. For example, the control circuitry 330 may comprise a logical sub-unit for controlling the recharging of the power source 340. Additionally, the control circuitry 330 may comprise a logical sub-unit for communication, e.g. to facilitate data transfer from or to the device 301. However, a primary function of the control circuitry 330 is to control the heating of aerosol generating material, as described in more detail below. It will be appreciated the functionality of the control circuitry 330 can be provided in various different ways, for example using one or more suitably programmed programmable computer(s) and/or one or more suitably configured application-specific integrated circuit(s)/circuitry/chip(s)/chipset(s) configured to provide the desired functionality. The control circuitry 330 is connected to the power supply 340 and may receive power from the power source 340 and may be configured to distribute or control the power supply to other components of the electronic vapor provision device 101. The control circuitry 130 is discussed as being connected to various components of the electronic vapor provision device 101, and it should be understood in each instance that this may be a direct or indirect connection.

However, the heating assembly 310 differs to that shown in FIG. 1. In a vapor provision device for heating a solid or gel form aerosol generating material, the heating assembly 310 comprises a heating chamber 380 within which the aerosol generating material can be inserted, for example within a consumable. Although not shown in FIG. 3, the mouthpiece 350 of this example is releasably attached to the outer housing 360 and is removed to permit access to the heating chamber 360. When reattached to the outer housing 360, the mouthpiece closes off the opening to the chamber 380. Again, although not shown, a part of the RF shield 311 (defined below) may be provided on/in the mouthpiece 350 (and potentially extending across the opening within the mouthpiece 350) to complete the RF shield 311 extending around and surrounding the heating chamber 380. The heating assembly 310 may be connected to the control circuitry 130, and uses radiofrequency (RF) electromagnetic radiation, such as microwave radiation, although other wavelengths may be used, to heat aerosol generating material received within the heating chamber 380. RF electromagnetic radiation refers to electromagnetic radiation having a frequency within the range 30 Hz to 300 GHz. The RF electromagnetic radiation may have a frequency of 3 kHz to 300 GHz, optionally 3 MHz to 100 GHz, optionally 30 MHz to 30 GHz. The heating assembly 310 may comprise a signal generator 370, such as a voltage controlled oscillator (“VCO”), to generate a signal which is provided to a connected amplifier 380. The amplifier 380 may be connected to one or more antennas 315, which are arranged within a heating cavity 320. In some embodiments, the one or more antennas 315 comprises one or more patch antenna. In another embodiment, the one or more antenna 315 comprises one or more directional antenna. The control circuitry 330 can control the RF electromagnetic radiation which is generated by the one or more antennas 315, and in embodiments the frequency spectra which is generated by the one or more antennas 315. The one or more antennas 315 may also be referred to as an antenna arrangement 315.

The heating cavity 320 is defined by RF shield 311, which substantially prevents the RF electromagnetic radiation generated by the one or more antennas 315 from escaping from the heating cavity 320. The RF shield 311 defines the heating cavity 320, by delimiting the volume within which RF electromagnetic radiation is substantially prevented from escaping, as will be discussed below. The one or more antennas 115 are arranged within the heating cavity 320. RF electromagnetic radiation may be prevented from escaping the heating cavity 320 by a combination of reflection and absorption of the RF electromagnetic radiation, and optionally the RF shield 311 may be configured to reflect more of the RF electromagnetic radiation back into the heating cavity 320 than is absorbed by the RF shield 311.

For instance, in the same manner as the RF shield 111 discussed above, the RF shield 311 may be configured to have a directional reflectance of 0.5 to 1.0, optionally 0.7 to 1.0, for the RF electromagnetic radiation generated by the antennas, the directional reflectance being the radiant flux reflected by a surface, divided by that received by that surface. The RF shield 311 may be configured to have a directional absorptance of 0.0 to 0.7, optionally 0.1 to 0.5, for the RF electromagnetic radiation generated by the antennas, the directional absorptance being the radiant flux absorbed by a surface, divided by that received by that surface. Further, the RF shield 311 may be configured to have a directional transmittance 0.0 to 0.3, optionally 0.1 to 0.2, for the RF electromagnetic radiation generated by the antennas, the directional transmittance being the radiant flux transmitted by a surface, divided by that received by that surface. Additionally, the RF shield may be configured to have an effective attenuation coefficient of at least 0.05 mm⁻¹ optionally at least 0.1 mm⁻¹, optionally at least 0.2 mm⁻¹, optionally at least 0.5 mm⁻¹, for the RF electromagnetic radiation generated by the antennas, where the effective attenuation coefficient is the radiant flux absorbed and scattered by a volume per unit length, divided by that received by that volume.

In some embodiments the RF shield 311 comprises a conductive material, a magnetic material, advantageously a conductive and magnetic material, and may comprise metal, for example aluminum, copper, brass, nickel, or other metals. Aluminum, copper, brass, and nickel are particularly useful as they have a desirably high degree of reflectance and shininess, in addition to conductivity. The RF shield 311 may comprise a substrate (e.g. an electrically insulating substrate) with a metallic coating, such as metallic ink. In embodiments the RF shield 311 may comprise an alloy comprising aluminum or copper. In some embodiments the RF shield 311 comprises a reflective foil. The RF shield 311 may comprise a sheet metallic material. In other embodiments, the RF shield 311 may comprise a metallic gauze or mesh. For instance, the RF shield 311 may comprise openings having a width of 5 mm or less, optionally 2.5 mm or less, optionally 1.5 mm or less, optionally 1.0 mm or less, optionally 0.5 mm or less, optionally 0.2 mm or less, optionally 0.1 mm or less. While any of these dimensions of openings may be applied to the liquid transport region or air permeable regions, as discussed below, openings having a width of 2.5 mm or less may be well suited to allowing both air and liquid, and a mixture of air, liquid, and/or vapor, to pass through, while openings having a width of 0.5 mm or less may be suitable for allowing liquid to pass through. These narrow openings are sufficient to substantially prevent the escape of the RF electromagnetic radiation from the heating cavity 320, while still permitting fluid to pass there through. In embodiments, the openings may have a width which is smaller than the smallest wavelength of the RF electromagnetic radiation generated by the antennas 115. Further, in regions of the RF shield 311 which comprise openings, (e.g. the liquid transport region or air permeable regions, as discussed below) the openings may cover 20% to 80%, optionally 40% to 60%, of the surface area in these regions. This proportion of openings may enable desirable volumes of fluid to pass through the RF shield 111, while remaining structurally stable.

As such, when the one or more antennas 315 are used to generate RF electromagnetic radiation, material within the cavity may become heated by exposure to this radiation, through the mechanism of dielectric heating in which polar molecules of the material within the cavity are driven to rotate by the RF electromagnetic radiation, thereby causing the material within the cavity to be vaporized. However, the RF shield 311 may be arranged to substantially prevent the RF electromagnetic radiation from escaping the cavity 320. This is important, particularly for an electronic vapor provision device which is handheld, as any RF electromagnetic radiation which did escape from the heating cavity 320 would escape in close proximity to the user. In one regard, providing the RF shield can help prevent the escape of RF radiation outside of the RF shield and thus provide a relatively safe heating mechanism (in respect of preventing the user from being exposed to RF radiation). Additionally, in instances where the RF shield is at least partially reflective to the RF radiation, the intensity of RF electromagnetic radiation generated may be increased within the bounds of the RF shield.

The aerosol generating material within the consumable which is inserted into the heating chamber 380 may be sufficient to generate aerosol for multiple inhalations by the user, in a given session. However, the consumable may be designed to be replaced for each session, and as such the amount of aerosol generating material within the consumable, and in particular within the heating cavity, may not be extensive. As discussed above, this may also be true for the aerosol provision device which is for heating a liquid aerosol generating material. As a result, in both the aerosol provision device for liquid aerosol generating material and the aerosol provision device for solid or gel form aerosol generating material, the bulk properties of the material within the heating cavity may change substantially over the course of an inhalation.

The aerosol provision device, regardless of the form of the aerosol generating material (liquid, solid, or gel), may be configured to apply heating of the aerosol generating material in one or more heating cycles. In particular, the control circuitry is configured to control the heating assembly, in particular the at least one antenna, such that RF electromagnetic radiation is applied over the course of one or more heating cycles, a set of one or more heat cycles corresponding to the generation of aerosol from the aerosol generating material for an inhalation.

The heating efficacy of aerosol generating material by within the heating cavity by exposure to RF electromagnetic radiation, in either a liquid arrangement or a solid or gel arrangement, is dependent upon the dielectric loss of the aerosol generating material. Dielectric loss is defined as a material's inherent dissipation of electromagnetic energy, and may depend upon the material composition and material temperature, and is also dependent upon the properties of the electromagnetic energy received. As such, by varying the generation of RF electromagnetic radiation during the course of an inhalation, or a heating cycle which is configured to generate the aerosol for a given inhalation, the aerosol provision device can adapt the heating with the variation in properties of the aerosol generating material.

During the course of one or more heating cycles or inhalations, the controller may be configured to vary one or more of several different properties of the RF electromagnetic radiation generated by the one or more antennas. As the temperature of aerosol generating material in the heating cavity changes, the relationship between dielectric loss and radiation frequency will change; so the frequency at which high efficacy heating occurs may be different. As such, one parameter which may be changed by the controller is the frequency of the RF electromagnetic radiation. The frequency of most efficient heating tends to increase with temperature, in the range of temperatures at which an aerosol provision device may operate, and as such the controller may be configured to increase the frequency of RF electromagnetic radiation over the course of one or more heating cycles or inhalations.

Another parameter which may vary over the course of one or more heating cycles or inhalations is the power of the RF electromagnetic radiation, as an initial period of high power RF electromagnetic radiation may be applied to bring the aerosol generating material to a temperature at which aerosol is generated, followed by a period of lower power RF electromagnetic radiation which is intended to maintain the aerosol generating material at a desired temperature. Here, the power may of the RF electromagnetic radiation may be increased by increasing the amplitude of the RF electromagnetic radiation.

The arrangement of the aerosol generating material within the heating cavity may also change during the course of one or more heating cycles or inhalations. For instance, in an consumable containing solid or gel form aerosol generating material, regions of the aerosol generating material may become heated at different speeds, and become depleted at different periods, over the course of one heating cycle or inhalations, or many heating cycles or inhalations. In the case of liquid aerosol generating material which arrives in a heating cavity via a liquid transport region, the liquid aerosol generating material may first be depleted in a given region. As such, the controller may vary the spatial distribution of the RF electromagnetic radiation generated by the one or more antennas to respond to this change in arrangement of aerosol generating material.

In embodiments, the controller is configured to vary the properties of the RF electromagnetic radiation generated by the at least one antenna over the course of one or more heating cycles or inhalations, in line with a predicted variation in properties of the aerosol generating material. For instance, predicted variation in properties of aerosol generating material over the course of one or more heating cycles or inhalations may depend on the composition of the aerosol generating material, and using this information, or other information, the control circuitry may be configured to select a predetermined variation in properties of the RF electromagnetic radiation accordingly. The aerosol provision device may comprise a consumable identification sensor, connected to the control circuitry, which is configured to identify the type of consumable received by the aerosol provision device, and may accordingly identify the material composition of the aerosol provision material received in the heating cavity, and may identify the arrangement of one or more aerosol provision materials in the heating cavity. The consumable identification sensor may be configured to identify a consumable identification component of the consumable. The consumable identification component may be configured to be optically recognised by a consumable identification sensor comprising a camera. The consumable identification component may be configured to be recognised by wireless electromagnetic interrogation, in which case the consumable identification sensor may be an electromagnetic transceiver.

In embodiments in which the aerosol generating material is in the form of a solid or gel, the consumable may be provided in the format of a rod, or other substantially rigid shape, which is inserted into the heating cavity; and, as such, the consumable identification sensor may be configured to identify the consumable in the cavity. In embodiments in which the aerosol generating material is in the form of a liquid, the consumable may be a cartridge which holds the liquid in a reservoir as discussed above, and the cartridge may not enter the heating cavity. Thus, in such arrangements, the consumable identification sensor may be configured to identify the consumable when it is received by and coupled to the electronic vapor provision device, but not necessarily within the cavity.

The user usage behaviour may also effect the predicted properties of the aerosol generating material over a given cycle. A consumable which has been used over a number of sessions or heating cycles may behave differently, and be more depleted in given regions, and a consumable which has been heated recently may still have some residual heat stored therein. As such, the control circuitry may vary the properties of the RF electromagnetic radiation in dependence of the user usage history. The control circuitry may also be configured to vary the properties of the RF electromagnetic radiation in dependence of the properties of the heating cycle applied. For instance, a longer heating cycle may have more significant temperature change and region specific depletion of the aerosol generating material.

In other embodiments, the vapor provision device also comprises one or more sensors for sensing measured properties relating to the aerosol generating material in the heating cavity. These sensors are connected to the controller, and the controller is configured to vary properties of the RF electromagnetic radiation in dependence of the measured properties. In one example, the properties of the RF electromagnetic radiation may be varied during one or more heating cycles or inhalations in dependence of the feedback from a puff sensor which is configured to detect the intensity or strength of a user inhalation.

If the user inhales very strongly, this may result in a rapid change in the properties of the aerosol generating material in the heating cavity, as the aerosol generated in the cavity may be depleted more quickly; and this is catered for by the control circuitry varying the properties of the RF electromagnetic radiation at a high rate. For instance, the controller may be configured to vary the frequency (or another property) of the RF electromagnetic radiation at a rate of variation which is a first rate which is set dependent upon the intensity or strength of the user inhalation, and increase the rate of variation as the user inhalation increases in intensity or strength or decrease the rate if the user inhalation decreases in intensity or strength. For instance, if a measured property is in a first range, e.g. above a predetermined level, then the rate may be increased, and if the measured property is in a second range, e.g. below a predetermined level, then the rate may be decreased. To consider, for example, the case that the measured property relates to the user's inhalation, a strong inhalation may correlate to a more rapid change in the temperature or volume of liquid in the heating cavity, meaning that it may be necessary to vary the frequency of the RF electromagnetic radiation more quickly in order to provide efficient heating.

In embodiments, the aerosol provision device is configured to vary the RF electromagnetic radiation over the course of one or more inhalations. The start and duration of these inhalations may be predicted, for example the controller may predict the start of an inhalation to occur at a predetermined time following the user activating the device, and for a predetermined duration. Alternatively, the start and duration of the inhalation may be detected by the one or more sensors, such as using the puff sensor, by using the measured properties; although other sensors such as a temperature sensor may also be usable for detecting when an inhalation starts and ends.

The variation in property of the RF electromagnetic radiation may be provided by continuously varying e.g. the frequency or power of the RF electromagnetic radiation in a continuous manner; which may enable fine control of the property variation. Alternatively, the properties of the RF electromagnetic radiation may be varied in a stepped manner, which may be less demanding on the control circuitry. In the case that the aerosol provision device comprises multiple antennas, the properties of the RF electromagnetic radiation may be varied by the controller controlling a first antenna to generate RF electromagnetic radiation, and subsequently controlling a second antenna to generate RF electromagnetic radiation. The first antenna may be arranged at a different position to the second antenna, to generate RF electromagnetic radiation directed at a different region of the heating cavity, or may be configured to transmit RF electromagnetic radiation at a different frequency or frequency range.

When the control circuitry controls the antenna or antennas in the heating assembly to generate RF electromagnetic radiation, this electromagnetic radiation is, in embodiments, generated in accordance with a particular schema. In particular, this means that the properties of the RF electromagnetic radiation are set in accordance with a schema of the control circuitry which sets out the properties of the RF electromagnetic radiation; for instance, the frequency, amplitude, and distribution of the RF electromagnetic radiation, which antenna is used to generate the RF electromagnetic radiation and when, and the time variation of these properties.

This schema is a predetermined schema, which is defined before the user activates the aerosol provision device to cause the heating assembly to initiate a heating cycle, for example by drawing on the device to trigger activation via a puff sensor, or by pressing a button on the device. For instance, this predetermined schema may be stored in the memory of the control circuitry before the user initiates the start of a heating cycle.

In some cases, the predetermined schema is defined as set by a user who is operating the aerosol provision device, or a secondary device such as a computer, phone, or tablet which is connected to the aerosol provision device, particularly to a signal receiver in the aerosol provision device which is connected to the control circuitry. The user can use a user interface of the aerosol provision device or the secondary device to, for example, select the properties of the RF electromagnetic radiation they want to use for aerosol generation. The user interface can then send instructions relating to the received inputs from the user to the control circuitry, and the signal receiver can receive signals from the secondary device, relating to user inputs on the secondary device, and send instructions to the control circuitry. The signal receiver may facilitate connection to the secondary device via a wired or wireless connection.

This could be done by selecting the desired predefined schema from a library of different predefined schema, or alternatively the user could define the properties of the predefined schema themselves, in advance of the initiation of the heating assembly. For instance, the user may prefer to inhale aerosol which provides a more strong flavor in some regards rather than others, and as such the user may select or define the predetermined schema to ensure that the frequency distribution of RF electromagnetic radiation which is applied to the aerosol generating material is conducive to more effectively heat materials within the composition which cause the generation of the desired flavors. In other regards, the user may desire a stronger, more intense, aerosol inhalation experience, in which case they may choose to select or define a predetermined schema which calls for more power to be applied to the consumable. Additionally, the user may also want to heat a particular region of a consumable which will result in the generation of a given aerosol from an aerosol generating material arranged within that region; so may accordingly may select or define a predetermined schema which causes the generation of RF electromagnetic radiation which is directed more intensely at that region.

In other arrangements, the predetermined schema may be defined or selected by the control circuitry in response to receiving information relating to the composition of the aerosol generating material. For instance, the aerosol provision device may comprise a consumable identity sensor which is configured to determine properties of an consumable which it receives, and pass this information to the control circuitry. The control circuitry can then select or define the predetermined schema in dependence of this information. For instance, different aerosol generating compositions may be effectively heated by RF electromagnetic when exposed to different frequencies. Further, some aerosol generating compositions may require higher power RF electromagnetic radiation to be applied to generate a satisfactory quantity of aerosol, whereas the power supplied for heating other materials can be advantageously reduced where possible to conserve battery usage. Different consumables may also comprise different spatial arrangements of aerosol generating compositions therein, or may be more efficiently heated when RF electromagnetic radiation is applied to a different region.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An electronic vapor provision device comprising:
at least one antenna for generating radio frequency (RF) electromagnetic radiation for heating an aerosol generating material to generate vapor; and
a controller for controlling one or more properties of the RF electromagnetic radiation generated by the at least one antenna, wherein the controller is configured to cause the at least one antenna to generate the microwave radiation in accordance with a predetermined schema which defines one or more properties of the RF electromagnetic radiation.

2. An electronic vapor provision device as claimed in claim 1, wherein the controller is configured to cause the at least one antenna to generate RF electromagnetic radiation for generating the vapor from the aerosol generating material in a heating cycle, and wherein the predetermined schema defines one or more properties of the RF electromagnetic radiation generated in the heating cycle.

3. An electronic vapor provision device as claimed in claim 2, wherein the controller is configured to prepare the predetermined schema in advance of the heating cycle.

4. An electronic vapor provision device as claimed in claim 3, wherein the controller is configured to prepare the predetermined schema by defining, selecting, or receiving the predetermined schema in advance of the heating cycle.

5. An electronic vapor provision device as claimed in claim 1, wherein the one or more properties of the RF electromagnetic radiation comprises the frequency of the RF electromagnetic radiation.

6. An electronic vapor provision device as claimed in claim 1, wherein the one or more properties of the RF electromagnetic radiation comprises the power of the RF electromagnetic radiation.

7. An electronic vapor provision device as claimed in claim 1, wherein the one or more properties of the RF electromagnetic radiation comprises the spatial distribution of the RF electromagnetic radiation.

8. An electronic vapor provision device as claimed in claim 1, comprising:
a user interface for receiving inputs from a user and configured to send instruction signals relating to the received inputs to the controller; and/or
a signal receiver configured to connect to a secondary device, receive signals relating to user inputs on the secondary device, and send instruction signals relating to the received signals to the controller.

9. An electronic vapor provision device as claimed in claim 8, wherein the controller is configured to define or select the predetermined schema in dependence of the instruction signals received by the controller.

10. An electronic vapor provision device as claimed in claim 8, wherein the controller is configured to define or select the predetermined schema in response to receiving the instruction signals.

11. An electronic vapor provision device as claimed in claim 1, wherein the controller is configured to define or select the predetermined schema in dependence of properties of the aerosol generating material received by the electronic vapor provision device.

12. An electronic vapor provision device as claimed in claim 11, further comprising a heating cavity configured to receive the aerosol generating material, and one or more sensors for determining one or more respective measured properties relating to the aerosol generating material.

13. An electronic vapor provision device as claimed in claim 12, wherein the electric vapor provision device is configured to receive a consumable comprising aerosol generating material, and wherein the one or more sensors comprises a consumable identification sensor, wherein the measured property determined by the consumable identification sensor is an identity of a consumable received by the electronic vapor provision device.

14. An electronic vapor provision device as claimed in claim 1, wherein the controller comprises memory, and wherein the controller is configured to select the predetermined schema from a plurality of stored predetermined schema which are stored in the memory.

15. An electronic vapor provision device as claimed in claim 1, wherein the controller is configured to vary the one or more properties of the RF electromagnetic radiation in accordance with the predetermined schema.

16. An electronic vapor provision system comprising:
an electronic vapor provision device as claimed in claim 1; and
a supply of liquid which in use is vaporized to form a vapor for inhalation by a user.

17. A method of generating vapor comprising:
generating radio frequency (RF) electromagnetic radiation for heating an aerosol generating material to generate vapor; and
controlling one or more properties of the RF electromagnetic radiation generated by the at least one antenna by causing the at least one antenna to generate the microwave radiation in accordance with a predetermined schema which defines one or more properties of the RF electromagnetic radiation.
